(19) United States
(12) Patent Application Publication
(10) Pub. No.: US 2008/0088609 A1
(43) Pub. Date: Apr. 17, 2008

(54) CONTROL SYSTEM WITH A DISPLAY INTERFACE FOR A FITNESS EQUIPMENT METER

(75) Inventors: Hsien-Lung CHOU, Taichung City (TW); Hsien-Nan CHOU, Taichung City (TW)

Correspondence Address: EGBERT LAW OFFICES, 412 MAIN STREET, 7TH FLOOR, HOUSTON, TX, 77002, US

(73) Assignee: KING I TECH CORPORATION, Taichung City (TW)

(21) Appl. No.: 11/549,959

(22) Filed: Oct. 16, 2006

(51) Int. Cl. G09G 5/00

(52) U.S. Cl. 345/204

(57) ABSTRACT

The present invention is a control system with a display interface for the fitness equipment meter. The control system includes an IC board and A/D board. The A/D board is connected to a display unit, and the information input from the IC board can be converted by A/D board and presented on the display. The IC board is fitted with a processor combined with display interface firmware to control the font on screen and the size, color and position of pattern. The A/D board executes only signal conversion. Therefore, the screen display patterns are controlled by the IC board, and A/D board can be universally applied to different models. An OSD display interface in the present invention achieves multiple-screen and dynamic display features in a cost-effective way.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

The present invention relates generally to a fitness equipment meter, and more particularly to an innovative device with a control system and display interface.

2. Description of Related Art Including Information Disclosed Under 37 CFR 1.97 and 37 CFR 1.98.

The control system of a fitness equipment meter generally comprises an IC board and an A/D board. During the operation process, the A/D board serves as a bridge to the IC board and display unit (LCD) such that information input from the IC board can be smoothly converted and then presented on the LCD screen with preset characters or patterns.

The control system of a typical fitness equipment meter is illustrated in FIG. 1. According to the embedded program of the A/D board, the data type input from the IC board (e.g. time, speed, pulse and calories) shall be presented on a certain section of display screen. Referring to FIG. 1, the embedded program of A/D board 10 has already assigned all displayed information into A, B, C, D sections of display unit 20. If all information input from IC board 30 to A/D board 10 are divided into an “a”, “b”, “c”, or “d”, then the task of A/D board 10 is to show “signal a” input from IC board 30 on section A of display unit 20, as marked by A1 in FIG. 1, or to show a “signal b” on section B of the display unit, and the like.

It is thus understood that the A/D board dictates the display position and mode of the control system of fitness equipment meter. Since A/D boards are generally made by specific manufacturers according to each embedded program, the operating mode of every batch of factory fitness equipment meters is fixed. The display position and mode of a display unit is also fixed, so that the operators of the fitness equipment meter cannot change the settings at their own discretion. When different models of fitness equipment meters with various display modes are to be developed, A/D board manufacturers are consigned to manufacture A/D boards with different programs. In such a case, different A/D boards cannot be interconnected, leading to excessive burden and costs of warehousing and management.

The display panel of a typical fitness equipment meter is also a key element to the display interface. Earlier, the display interface was usually made of monochromatic liquid crystal panels, presenting excessively dull color and positions for the operators.

Although some efforts are made to integrate the computer system and display interface into fitness equipment to dramatically improve its functionality and to achieve a more vivid and dynamic display, some disputes on the cost-effectiveness are also raised, since fitness equipment is just an auxiliary tool in everyday life. However, competitive power and customer recognition will be affected due to a sharp increase of cost of fitness equipment.

Thus, to overcome the aforementioned problems of the prior art, it would be an advancement in the art to provide an improved structure that can significantly improve efficacy.

To this end, the inventor has provided the present invention of practicability after deliberate design and evaluation based on years of experience in the production, development and design of related products.

### BRIEF SUMMARY OF THE INVENTION

There is enhanced efficacy in the present invention. The present invention offers a unique control system for the fitness equipment meter. The processor 53 of IC board 51 is combined with display interface firmware to control the font on screen 61 and the size, color and position of a pattern 70. Hence, A/D board 52 executes only signal conversion. So, the screen display patterns are controlled by IC board 51, and the display interface firmware is embedded into the processor 53 of IC board 51. A/D board 52 can be universally applied to different models, thereby greatly reducing the cost of warehousing and management for better efficiency.

The display interface of the present invention may be an OSD interface 80 with less memory space, such as 32 MB and below, allowing a display at any position of the screen or superimposing with existing images. The fitness equipment meter may achieve multiple-screen and dynamic displays in a cost-effective way.

Although the invention has been explained in relation to its preferred embodiment, it is to be understood that many other possible modifications and variations can be made without departing from the spirit and scope of the invention as hereinafter claimed.

### BRIEF DESCRIPTION OF THE SEVERAL VIEWS OF THE DRAWINGS

FIG. 1 shows a schematic view of a control system for a typical fitness equipment meter of the prior art.

FIG. 2 shows a schematic view of the control system for a fitness equipment meter of the present invention.

FIG. 3 shows a schematic view of the OSC interface of the control system for a fitness equipment meter of the present invention.

FIG. 4 shows another schematic view of the OSC interface of the control system for a fitness equipment meter of the present invention.

FIG. 5 shows still another schematic view of the OSC interface of the control system for a fitness equipment meter of the present invention.

FIG. 6 shows yet another schematic view of the OSC interface of the control system for a fitness equipment meter of the present invention.

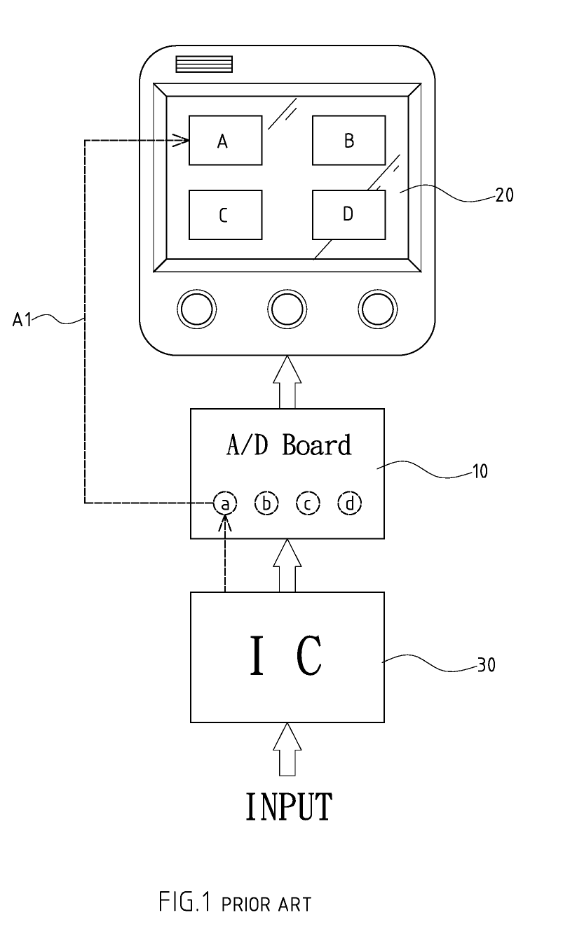

### DETAILED DESCRIPTION OF THE INVENTION

The features and the advantages of the present invention will be more readily understood upon a thoughtful deliberation of the following detailed description of a preferred embodiment of the present invention with reference to the accompanying drawings.

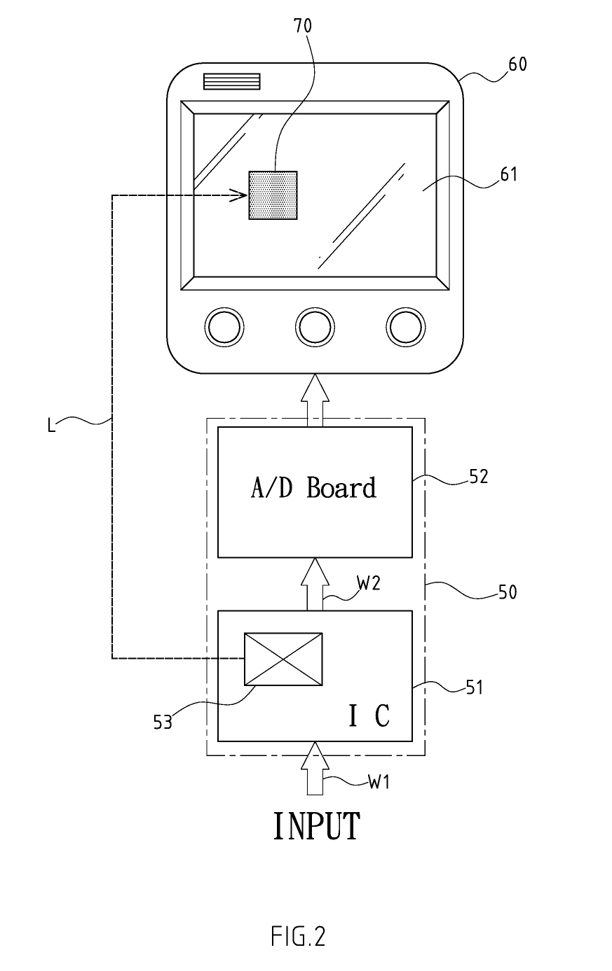

FIG. 2 depicts a preferred embodiment of the control system with display interface for a fitness equipment meter of the present invention. The preferred embodiment is provided for explanatory purposes only. The scope of the invention is set by the patent claims.

The control system 50 includes an IC board 51, and an A/D board 52. The A/D board 52 is connected to a preset display unit 60, e.g. an LCD, and information input from IC board 51 can be converted by A/D board 52 and then presented on screen 61 of display unit 60. The IC board 51 comprises a processor 53. The processor 53 of IC board 51 is fitted with display interface firmware. The display interface firmware is used to control the font on screen 61, and the size, color and position of pattern 70. Hence, the embedded program of A/D board 52 executes only signal conversion, namely, the font on screen 61 of display unit 60, and the size, color and position of pattern 70 are controlled by IC board 51.

The control system of a fitness equipment meter of the present invention is operated as illustrated in FIG. 2. When signal W1 is input to IC board 51, display interface firmware in the processor 53 will process signal W1, then decide and control the font on screen 61 of display unit 60, or the size, color and position of pattern 70. The IC board 51 dictates the font on screen 61 or the display mode on pattern 70 (marked by L in FIG. 2). Next, signal W2 is converted by A/D board 52 and then presented on screen 61 of display unit 60.

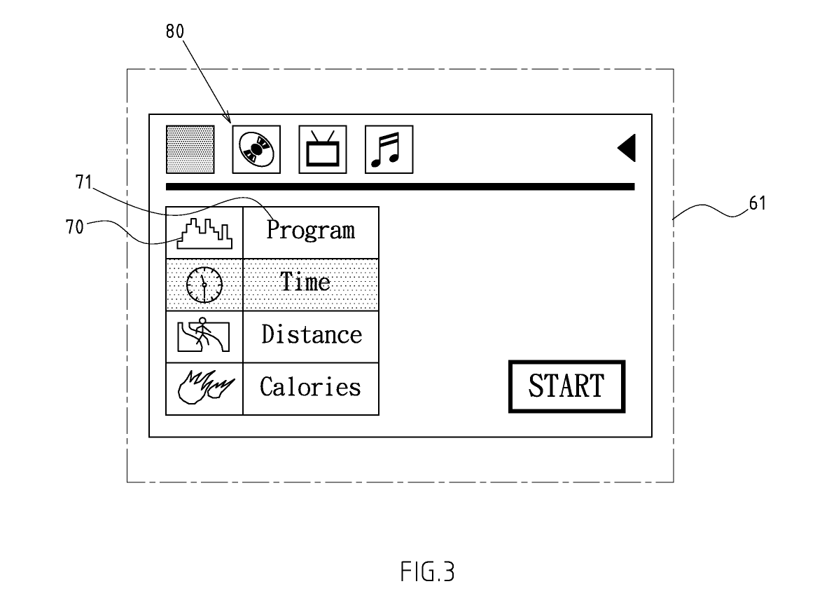

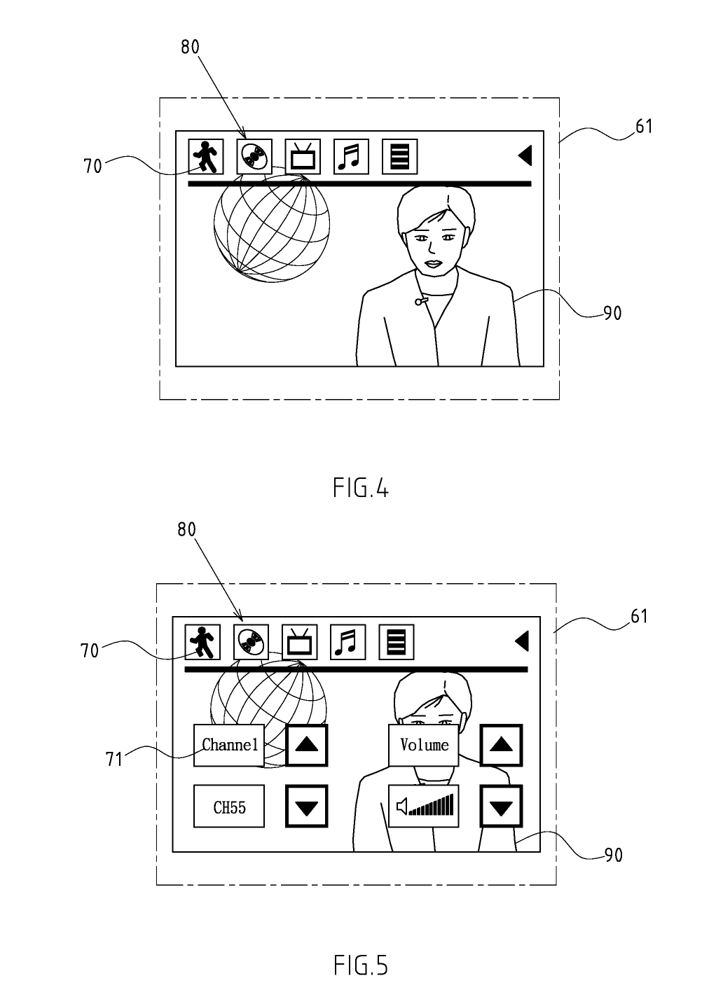

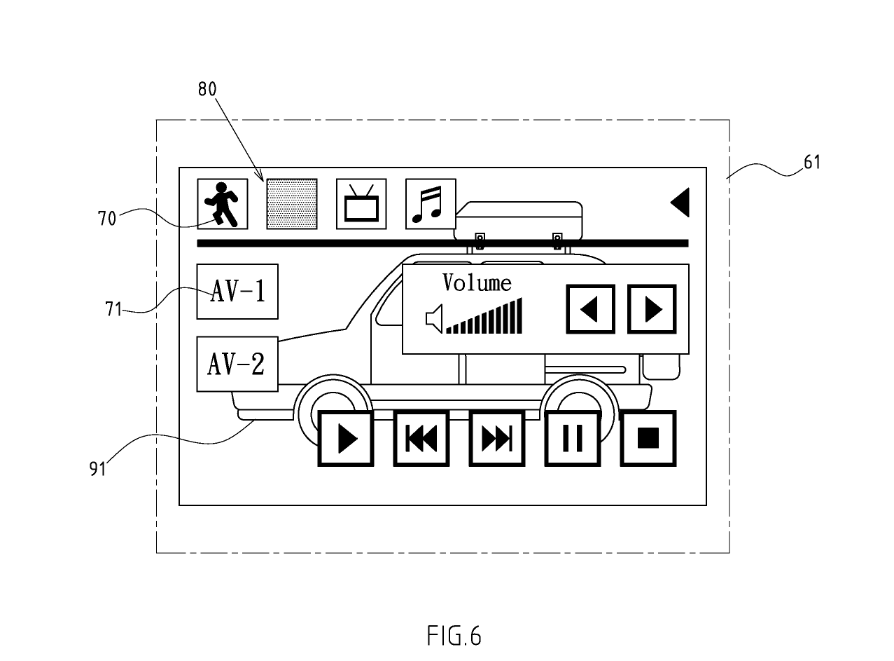

Moreover, the present invention also offers a display interface of a fitness equipment meter, as illustrated in FIG. 3. The display interface is an OSD (On Screen Display) interface 80, which is an on-screen control IC. With a lower memory space, OSD interface 80 allows the information to be shown at any position on the screen or superimposed with existing images. OSD interface 80 requires only a memory space ranging from 8 KB to 32 MB in order to meet the functional requirements of a fitness equipment meter, the font and pattern of the OSD interface being formed by encoding and not by storing an image file. Referring to FIG. 3, OSD interface 80 may display plain color on screen 61 with an esthetically pleasing pattern 70 and character 71. Also, OSD interface 80 and display unit 60, illustrated in FIG. 2, can be configured with an existing TV signal line or CD-ROM signal line. Referring to FIGS. 4 and 5, the background of OSD interface 80 is an image screen 90 of TV, so pattern 70 and character 71 of OSD interface 80 allow full or partial hiding, if necessary, as illustrated in FIG. 4, or complete superimposing onto the image screen 90, as illustrated in FIG. 5. OSD interface 80 may also be in a semi-transparent state to minimize the interference and influence upon the background. Referring also to FIG. 6, pattern 70 and character 71 of OSD interface 80 are superimposed onto image screen 91 input from a CD-ROM as mentioned above.

The OSD interface 80 achieves a multiple-screen and dynamic display for a fitness equipment meter in a cost-effective way.

We claim:

1. A control system for a fitness equipment meter, comprising:
an IC board being comprised of a processor for signal processing; and
an A/D board, being connected with a preset display unit and converting information input from said IC board, said preset display unit having a screen presenting the converted information input, wherein said processor of said IC board is fitted with display interface firmware, controlling said screen by font, size, color and position of pattern, said A/D board only executing signal conversion.

2. A control system with a display interface for a fitness equipment meter, said control system comprising:
an IC board being comprised of a processor for signal processing; and
an A/D board being connected with a preset display unit and converting information input from said IC board, said preset display unit having a screen and a preset display interface presenting the converted information input, wherein said processor of said IC board is fitted with display interface firmware, controlling said screen by font, size, color and position of pattern, said A/D board only executing signal conversion, and wherein said display interface is an OSD interface allowing display at any position of said screen or superimposing with existing images.

3. The control system with a display interface defined in claim 2, wherein said OSD interface requires a memory ranging from 8 KB to 32 MB.

4. The control system with a display interface defined in claim 2, wherein said preset display unit is connected with both TV signal line and CD-ROM signal line.
